(19) United States
(12) Patent Application Publication
(10) Pub. No.: US 2024/0127428 A1
(43) Pub. Date: Apr. 18, 2024

(54) SYSTEM AND METHOD FOR PROBABILISTIC DETECTION OF TOOTH CAVITIES USING MACHINE LEARNING

(71) Applicant: MARLABS LLC, PISCATAWAY, NJ (US)

(72) Inventors: UDAY VIDYADHARAN, EAST BRUNSWICK, NJ (US); SRINIVASAN BALRAM, RESTON, VA (US)

(21) Appl. No.: 18/164,685

(22) Filed: Feb. 6, 2023

Related U.S. Application Data
(60) Provisional application No. 63/379,295, filed on Oct. 13, 2022.

(51) Int. Cl. G06T 7/00; G06T 3/40; G06T 5/20; G06V 10/25; G06V 10/46

(52) U.S. Cl. CPC G06T 7/0012; G06T 3/4053; G06T 5/20; G06V 10/25; G06V 10/46; G06T 2207/10024; G06T 2207/20084; G06T 2207/20096; G06T 2207/30036

(57) ABSTRACT

A system and method for probabilistic detection of tooth cavities using machine learning is provided. The system includes a contour detection module to identify contours from a dental image thereby selecting areas of interest to analyze for a probability of occurrence of a cavity and processing the contours by applying filters thereby converting the dental image into a grayscale image. The system includes a user selection module to allow a user to select contours. The system includes a pre-processing module to isolate the contours into bounding boxes based on a ratio and convert the bounding boxes into pre-defined pixels using a machine learning model. The system includes a machine learning pipeline to analyze the contours using the machine learning model thereby identifying the presence of a cavity. The system includes an output module to display a label corresponding to the contours, wherein the label indicates a probability of occurrence of a cavity.

### EARLIEST PRIORITY DATE

This application claims priority from a Provisional patent application filed in the United States of America having Patent Application No. 63/379,295, filed on Oct. 13, 2022, and titled “A CAVITY DETECTION SYSTEM AND METHOD FOR OPERATING THE SAME.”

### FIELD OF INVENTION

Embodiments of the present disclosure relate to the field of dentistry, and more particularly, a system and a method for probabilistic detection of tooth cavities using machine learning.

### BACKGROUND

Although improvements have been made in detection, treatment and prevention techniques, dental cavities remain affecting people of all ages. Typically, tooth cavity detection methods include visual inspection and tactile probing using a sharp dental probe device, often assisted by radiographic (x-ray) imaging. Detection using this method is based on several factors, including the experience of the practitioner, the location of the infected site, the extent of infection, the viewing condition, the accuracy of x-ray equipment and treatment.

False or inconsistent readings of X-ray images and other medical radiographs are potential risks. X-rays of a patient's teeth are examined by a dentist for diagnostic or other purposes. In the field of dentistry, dental practice often uses conventional computer software to manage, and review captured radiographs as digital image files. Some of these conventional software or related computer tools allow the dentist to further review digital files and to more manually mark features of interest observed by the dentist in a given radiographic image. However, the conventional methods fail to achieve accuracy and are time consuming.

Hence, there is a need for an improved system and method for detecting tooth cavities from X-ray images using machine learning to addresses the aforementioned need(s).

### BRIEF DESCRIPTION

In accordance with an embodiment of the present disclosure, a system for probabilistic detection of tooth cavities using machine learning is provided. The system includes a processing subsystem hosted on a server. The processing subsystem is configured to execute on a network to control bidirectional communications among a plurality of modules. The processing subsystem includes an image acquisition module configured to receive a dental image from an image capturing device coupled to a computing device. The processing subsystem includes a contour detection module configured to identify a plurality of contours from the dental image thereby selecting a plurality of areas of interest to analyze for a probability of occurrence of a cavity in the dental image and processing the plurality of contours by applying one or more filters thereby converting the dental image into a corresponding grayscale image. The processing subsystem includes a user selection module operatively coupled to the contour detection module wherein the user selection module is configured to allow a user to select one or more contours from the plurality of contours identified by the contour detection module. The processing subsystem includes a pre-processing module operatively coupled to the user selection module wherein the pre-processing module is configured to isolate each of one or more contours, selected by the user, into one or more bounding boxes based on a ratio using a machine learning model and convert the one or more bounding boxes into corresponding pre-defined pixels using the machine learning model. Further, the processing subsystem includes a machine learning pipeline operatively coupled to the pre-processing module wherein the machine learning pipeline is configured to analyze the one or more contours using the machine learning model, upon isolating, thereby identifying the presence of a cavity. Furthermore, the processing subsystem includes an output module operatively coupled to the pre-processing module wherein the output module is configured to display a label corresponding to each of the one or more contours, wherein the label indicates a probability of occurrence of a cavity.

In accordance with another embodiment of the present disclosure a computer-implemented method for probabilistic detection of tooth cavities using machine learning is provided. The computer-implemented method includes receiving, by an image acquisition module of a processing subsystem, a dental image from an image capturing device coupled to a computing device. The computer-implemented method includes identifying, by a contour detection module of the processing subsystem, a plurality of contours from a dental image thereby selecting a plurality of areas of interest to analyze for a probability of occurrence of a cavity in the dental image. The computer-implemented method includes processing, by the contour detection module of the processing subsystem, the plurality of contours by applying one or more filters thereby converting the dental image into a corresponding grayscale image. The computer-implemented method also includes allowing, by a user selection module of the processing subsystem, a user to select one or more contours from the plurality of contours identified by the contour detection module. Further, the computer-implemented method includes isolating, by a pre-processing module of the processing subsystem, each of one or more contours, selected by the user, into one or more bounding boxes based on a ratio using a machine learning model. Furthermore, the computer-implemented method includes converting, by the pre-processing module of the processing subsystem, the one or more bounding boxes into corresponding pre-defined pixels using the machine learning model. Moreover, the computer-implemented method includes analyzing, by a machine learning pipeline of the processing subsystem, the one or more contours using the machine learning model, upon isolating, thereby identifying the presence of a cavity. The computer-implemented method includes displaying, by an output module of the processing subsystem, a label corresponding to each of the one or more contours, wherein the label indicates a probability of occurrence of a cavity.

In accordance with yet another embodiment of the present disclosure, a non-transitory computer-readable medium storing a computer program that, when executed by a processor, causes the processor to perform a computer-implemented method for probabilistic detection of tooth cavities using machine learning is provided. The computer-implemented method includes receiving, by an image acquisition module of a processing subsystem, a dental image from an image capturing device coupled to a computing device. The computer-implemented method includes identifying, by a contour detection module of the processing subsystem, a plurality of contours from a dental image thereby selecting a plurality of areas of interest to analyze for a probability of occurrence of a cavity in the dental image. The computer-implemented method includes processing, by the contour detection module of the processing subsystem, the plurality of contours by applying one or more filters thereby converting the dental image into a corresponding grayscale image. The computer-implemented method also includes allowing, by a user selection module of the processing subsystem, a user to select one or more contours from the plurality of contours identified by the contour detection module. Further, the computer-implemented method includes isolating, by a pre-processing module of the processing subsystem, each of one or more contours, selected by the user, into one or more bounding boxes based on a ratio using a machine learning model. Furthermore, the computer-implemented method includes converting, by the pre-processing module of the processing subsystem, the one or more bounding boxes into corresponding pre-defined pixels using the machine learning model. Moreover, the computer-implemented method includes analyzing, by a machine learning pipeline of the processing subsystem, the one or more contours using the machine learning model, upon isolating, thereby identifying the presence of a cavity. The computer-implemented method includes displaying, by an output module of the processing subsystem, a label corresponding to each of the one or more contours, wherein the label indicates a probability of occurrence of a cavity.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system for probabilistic detection of tooth cavities using machine learning in accordance with an embodiment of the present disclosure;

FIG. 2 is a block diagram of a computer or a server in accordance with an embodiment of the present disclosure; and

FIG. 3 illustrates a flow chart representing the steps involved in a method for probabilistic detection of tooth cavities using machine learning in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

In the following description, certain terminology is used to describe features of the invention. The term “machine learning” refers to a subfield of computer science that focuses on the development of computer programs capable of accessing and using data to learn for themselves, without being explicitly programmed to do so.

The term “deep learning” refers to a subset of machine learning that involves networks which are capable of “learning” based on data representations, rather than task-specific algorithms. “Deep learning” can be supervised, semi-supervised, or unsupervised. Deep learning models are loosely related to information processing and communication patterns in a biological nervous system, such as neural coding that attempts to define a relationship between various stimuli and associated neural responses in the brain.

The term “convolutional neural network” (CNN) refers to a class of deep, feed-forward artificial neural networks that can be used to analyze visual imagery and include at least one convolutional layer.

In accordance with an embodiment of the present disclosure, a system for probabilistic detection of tooth cavities using machine learning is provided. The system includes a processing subsystem hosted on a server. The processing subsystem is configured to execute on a network to control bidirectional communications among a plurality of modules. The processing subsystem includes an image acquisition module configured to receive a dental image from an image capturing device coupled to a computing device. The processing subsystem includes a contour detection module configured to identify a plurality of contours from the dental image thereby selecting a plurality of areas of interest to analyze for a probability of occurrence of a cavity in the dental image and processing the plurality of contours by applying one or more filters thereby converting the dental image into a corresponding grayscale image. The processing subsystem includes a user selection module operatively coupled to the contour detection module wherein the user selection module is configured to allow a user to select one or more contours from the plurality of contours identified by the contour detection module. The processing subsystem includes a pre-processing module operatively coupled to the user selection module wherein the pre-processing module is configured to isolate each of one or more contours, selected by the user, into one or more bounding boxes based on a ratio using a machine learning model and convert the one or more bounding boxes into corresponding pre-defined pixels using the machine learning model. Further, the processing subsystem includes a machine learning pipeline operatively coupled to the pre-processing module wherein the machine learning pipeline is configured to analyze the one or more contours using the machine learning model, upon isolating, thereby identifying the presence of a cavity. Furthermore, the processing subsystem includes an output module operatively coupled to the pre-processing module wherein the output module is configured to display a label corresponding to each of the one or more contours, wherein the label indicates a probability of occurrence of a cavity.

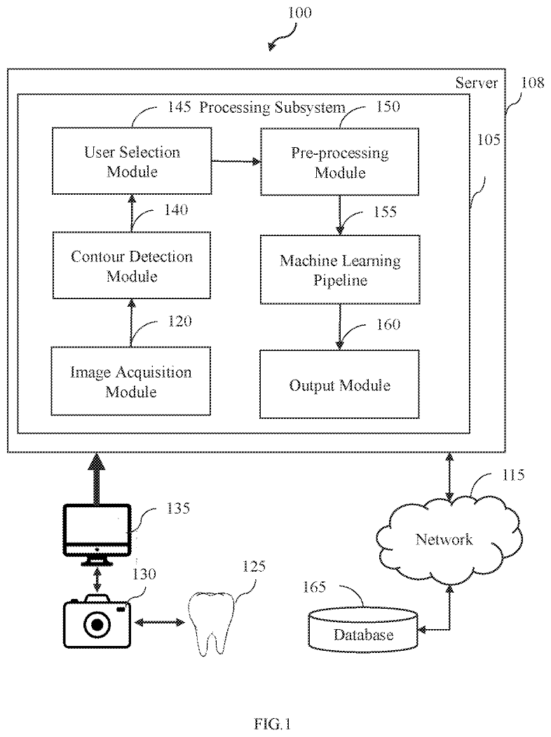

FIG. 1 is a block diagram representation of a system for probabilistic detection of tooth cavities using machine learning in accordance with an embodiment of the present disclosure. The system (100) includes a processing subsystem (105) hosted on a server (108). In one embodiment, the server (108) may include a cloud-based server. In another embodiment, parts of the server (108) may be a local server coupled to a computing device (135). Examples of the computing device (135), includes but is not limited to a personal computer (PC), a mobile phone, a tablet device, a personal digital assistant (PDA), a smart phone, a laptop, and pagers. The processing subsystem (105) is configured to execute on a network (115) to control bidirectional communications among a plurality of modules. In one example, the network (115) may be a private or public local area network (LAN) or Wide Area Network (WAN), such as the Internet. In another embodiment, the network (115) may include both wired and wireless communications according to one or more standards and/or via one or more transport mediums. In one example, the network (115) may include wireless communications according to one of the 802.11 or Bluetooth specification sets, or another standard or proprietary wireless communication protocol. In yet another embodiment, the network (15) may also include communications over a terrestrial cellular network, including, a global system for mobile communications (GSM), code division multiple access (CDMA), and/or enhanced data for global evolution (EDGE) network.

The processing subsystem (105) includes an image acquisition module (120) configured to receive a dental image (125) from an image capturing device (130) coupled to a computing device (135). Examples of the image capturing device (130) include, but is not limited to, intraoral cameras, digital intraoral X-ray sensors, panoramic X-ray machines, and cephalometric X-ray machines. Examples of the computing device (135) includes, but is not limited to, a personal computer, a local server or a remote server. Typically, the dental image (125) is a color image of a tooth of the user. The color image is in the Red Green Blue (RGB) format.

The processing subsystem (105) includes a contour detection module (140) operatively coupled to the image acquisition module (120) and configured to identify a plurality of contours from the dental image (125) thereby selecting a plurality of areas of interest to analyze for a probability of occurrence of a cavity in the dental image (125). Further, the contour detection module (140) is configured to process the plurality of contours by applying one or more filters thereby converting the dental image (125) into a corresponding grayscale image. Furthermore, the one or more filters comprises a two-dimensional convolution high pass filter, a binary threshold filter, a contour recognition filter, a color based contour filter and a hierarchical based contour filter.

The processing subsystem (105) includes a user selection module (145) operatively coupled to the contour detection module (140) and configured to allow a user to select one or more contours from the plurality of contours identified by the contour detection module (140).

The processing subsystem (105) includes a pre-processing module (150) operatively coupled to the user selection module (145) and configured to isolate each of one or more contours, selected by the user, into one or more bounding boxes based on a ratio using a machine learning model. Further, the pre-processing module (150) is configured to convert the one or more bounding boxes into corresponding pre-defined pixels using the machine learning model. The machine learning model is trained via methods of machine learning (specifically deep learning utilizing neural networks) to aid in the performance of tasks that are typically done manually by dental office staff. The system (100) described herein can be deployed to both cloud webservices and individual devices, and methods for training the machine learning model.

The machine learning model is a deep convolution neural network. It will be appreciated to those skilled in the art that the machine learning model may be trained by any other suitable machine learning model. Examples of other machine learning models include, but are not limited to, a Deep Neural Network (DNN), Convolutional Neural Network (CNN), Restricted Boltzmann Machine (RBM), Deep Belief Network (DBN) and Deep Q-Networks.

Further, the machine learning model is configured to analyze the one or more contours by recognizing one or more patterns that proposes a probability of the presence of the cavity. Furthermore, the machine learning model is configured with a training set of various sizes of dental images thereby producing accuracy in the probability of occurrence of the cavity.

The pre-processing module (150) is also configured to perform at least one of an upscale of the one or more contours and a downscale of the one or more contours to increase resolution of the dental image (125).

The processing subsystem (105) includes a machine learning pipeline (155) operatively coupled to the pre-processing module (150) and configured to analyze the one or more contours using the machine learning model, upon isolating, thereby identifying the presence of a cavity.

The processing subsystem (105) includes an output module (160) operatively coupled to the machine learning pipeline (155) and configured to display a label corresponding to each of the one or more contours, wherein the label indicates a probability of occurrence of a cavity. Specifically, the label is a binary value that represents one of a presence and absence of the cavity within the one or more contours of the dental image (125).

The database (165) is configured to store dental images and corresponding labels that represents an occurrence of a cavity.

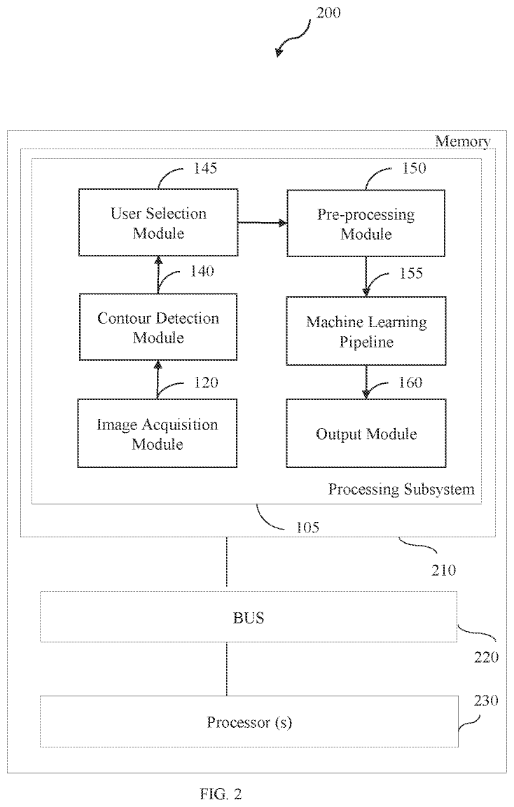

FIG. 2 is a block diagram of a computer or a server in accordance with an embodiment of the present disclosure. The server (200) includes processor(s) (230), and memory (210) operatively coupled to the bus (220). The processor(s) (230), as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory (210) includes several subsystems stored in the form of executable program which instructs the processor (230) to perform the method steps illustrated in FIG. 1. The memory (210) includes a processing subsystem (105) of FIG. 1. The processing subsystem (105) further has following modules: an image acquisition module (120), a contour detection module (140), a user selection module (145), a pre-processing module (150), a machine learning pipeline (155) and an output module (160).

In accordance with an embodiment of the present disclosure, a system (100) for detecting teeth cavities using machine learning is provided. The system (100) includes a processing subsystem (105) hosted on a server (108). The processing subsystem (105) is configured to execute on a network to control bidirectional communications among a plurality of modules. The processing subsystem (105) includes an image acquisition module (120) configured to receive a dental image (125) from an image capturing device (130) coupled to a computing device (135). The processing subsystem includes a contour detection module (140) configured to identify a plurality of contours from the dental image (125) thereby selecting a plurality of areas of interest to analyze for a probability of occurrence of a cavity in the dental image (125) and processing the plurality of contours by applying one or more filters thereby converting the dental image (125) into a corresponding grayscale image. The processing subsystem includes a user selection module (145) operatively coupled to the contour detection module (140) wherein the user selection module (145) is configured to allow a user to select one or more contours from the plurality of contours identified by the contour detection module (140). The processing subsystem includes a pre-processing module (150) operatively coupled to the user selection module (145) wherein the pre-processing module (150) is configured to isolate each of one or more contours, selected by the user, into one or more bounding boxes based on a ratio using a machine learning model and convert the one or more bounding boxes into corresponding pre-defined pixels using the machine learning model. Further, the processing subsystem includes a machine learning pipeline (155) operatively coupled to the pre-processing module wherein the machine learning pipeline is configured to analyze the one or more contours using the machine learning model, upon isolating, thereby identifying the presence of a cavity. Furthermore, the processing subsystem includes an output module (160) operatively coupled to the pre-processing module (150) wherein the output module (160) is configured to display a label corresponding to each of the one or more contours, wherein the label indicates a probability of occurrence of a cavity.

The bus (220) as used herein refers to internal memory channels or computer network that is used to connect computer components and transfer data between them. The bus (220) includes a serial bus or a parallel bus, wherein the serial bus transmits data in bit-serial format and the parallel bus transmits data across multiple wires. The bus (220) used herein may include but not limited to, a system bus, an internal bus, an external bus, an expansion bus, a frontside bus, a backside bus and the like.

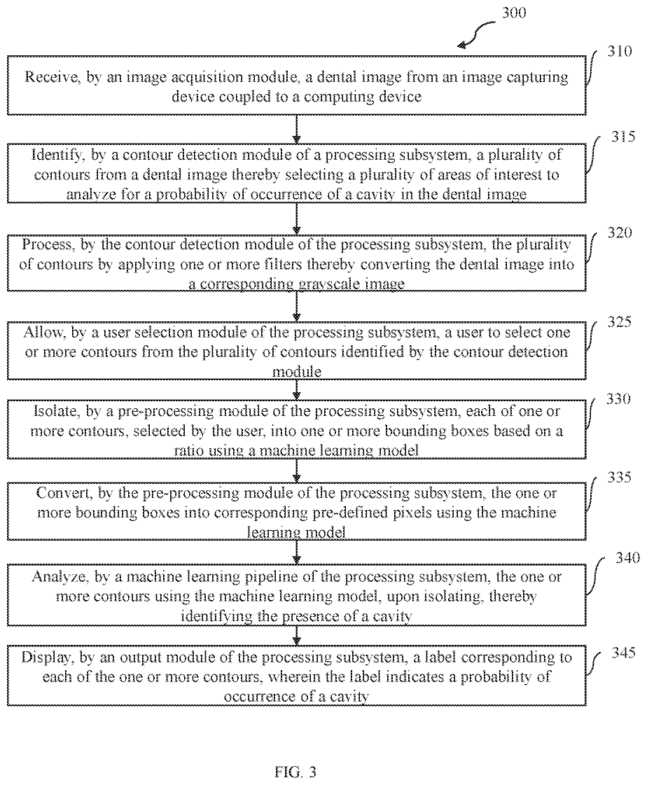

FIG. 3 illustrates a flow chart representing the steps involved in a method for detecting tooth cavities using machine learning in accordance with an embodiment of the present disclosure. The flow chart begins at step (310). The method includes receiving, by an image acquisition module, a dental image from an image capturing device coupled to a computing device in step (310). Typically, the image capturing device is a dental image device to capture and transfer images to the image acquisition module. The dental image is sent to the image acquisition module either by a direct, wired connection or as a radio signal or wireless network connection. Further, the dental image is an RGB image of a patient's teeth.

The method includes identifying, by a contour detection module of a processing subsystem, a plurality of contours from a dental image thereby selecting a plurality of areas of interest to analyze for a probability of occurrence of a cavity in the dental image in step (315). Upon image acquisition and delivery to the image capturing device, the processing of the dental image begins through one or more convolutional neural networks.

The method also includes processing, by the contour detection module of the processing subsystem, the plurality of contours by applying one or more filters thereby converting the dental image into a corresponding grayscale image in step (320).

The filters include a 2D convolution high pass filter for increasing sharpness of edges (this helps in identifying contours), a binary threshold filter, a contour recognition filter to identify sharp changes in brightness of pixels in the dental image, a color based contour filter and a hierarchical based contour filter. In one embodiment, better filters that improve image quality will improve the probability of detection of cavities.

The method also includes allowing, by a user selection module of the processing subsystem, a user to select one or more contours from the plurality of contours identified by the contour detection module in step (325). The user is a dental healthcare provider who is allowed to select one or more contours that he/she wants to investigate for a possibility of a cavity in a corresponding area of interest.

The method also includes isolating, by a pre-processing module of the processing subsystem, each of one or more contours, selected by the user, into one or more bounding boxes based on a ratio using a machine learning model in step (330). The ratio defines the size of the one or more bounding boxes.

The method also includes converting, by the pre-processing module of the processing subsystem, the one or more bounding boxes into corresponding pre-defined pixels using the machine learning model in step (335). The one or more bounding boxes are either upscaled or downscaled based on their corresponding resolution. Specifically, the one or more bounding boxes are upscaled or downscaled to 512×512 pixels. It must be noted that although the foregoing discussion defines the resolution of 512×512 pixels, the one or more bounding boxes may be upscaled or downscaled based on any other suitable resolution.

The method also includes analyzing, by a machine learning pipeline of the processing subsystem, the one or more contours using the machine learning model, upon isolating, thereby identifying the presence of a cavity in step (340).

Specifically, a convolutional neural network is used to train the machine learning model. In one embodiment, the machine learning model is trained using a statistically significant sample of images that have been pre-labeled or numbered according to the cavity present in the image and optionally the orientation of the image capturing device that took the image.

Typically, the machine learning pipeline is configured with machine learning models. The machine learning models may be trained using the process of backpropagation or another form of automatic differentiation. Training data may include, for example, pre-labeled or pre-classified images from traditional imaging software, electronic health records, converted paper records, or data gathered using a software-as-a-service or cloud platform. Pre-processing of image data may vary widely depending on the exact implementation or embodiment of the invention and the input data, but can include, for example, the resizing of images to some standardized dimensions, the interpretation of positional indicators of sensors into some standardized form, conversion of images to a standardized “bit-ness” or color depth, cropping images or otherwise modifying their aspect ratio to a standardized value, the normalization of image pixel values, reducing the dimensionality of colored (non-grayscale) images, or perturbation of the training data to augment the size and robustness of the training data set.

It must be noted that the neural network can be deployed as a software package for integration into a standalone personal computer application, a local server, or to a remote server for offsite processing.

The method also includes displaying, by an output module of the processing subsystem, a label corresponding to each of the one or more contours, wherein the label indicates a probability of occurrence of a cavity in step (345).

In one embodiment, the label can indicate the probability of the dental image having been acquired with the image acquisition device in a certain orientation or at a certain location in the mouth, or the probability that the dental image includes certain teeth and the locations of those teeth, or probabilities corresponding to the ideal parameters to apply to image enhancement filters/algorithms, or the probability of an image or section of tooth containing caries/cavities, or any combination of those probabilities, depending on user selection or system configuration.

The method ends at step (345).

Various embodiments of the present disclosure provide an automated system and method that helps to detect potential cavities in teeth with high accuracy and at a faster rate thereby saving time for the doctors.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application-specific integrated circuits (ASICs), field-programmable gate arrays (FPGAs), or any other equivalent integrated or discrete logic circuitry, as well as any combinations of such components. The term “processor” or “processing subsystem” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules, or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for probabilistic detection of tooth cavities using machine learning comprising:
a processing subsystem hosted on a server, wherein the processing subsystem is configured to execute on a network to control bidirectional communications among a plurality of modules comprising:
an image acquisition module configured to receive a dental image from an image capturing device coupled to a computing device;
a contour detection module configured to:
identify a plurality of contours from the dental image thereby selecting a plurality of areas of interest to analyze for a probability of occurrence of a cavity in the dental image; and
processing the plurality of contours by applying one or more filters thereby converting the dental image into a corresponding grayscale image;
a user selection module operatively coupled to the contour detection module wherein the user selection module is configured to allow a user to select one or more contours from the plurality of contours identified by the contour detection module;
a pre-processing module operatively coupled to the user selection module wherein the pre-processing module is configured to:
isolate each of one or more contours, selected by the user, into one or more bounding boxes based on a ratio using a machine learning model; and
convert the one or more bounding boxes into corresponding pre-defined pixels using the machine learning model;
a machine learning pipeline operatively coupled to the pre-processing module wherein the machine learning pipeline is configured to analyze the one or more contours using the machine learning model, upon isolating, thereby identifying the presence of a cavity;
an output module operatively coupled to the pre-processing module wherein the output module is configured to display a label corresponding to each of the one or more contours, wherein the label indicates a probability of occurrence of a cavity.

2. The system as claimed in claim 1 wherein the machine learning model is a deep convolution neural network.

3. The system as claimed in claim 1 wherein the machine learning model is configured to analyze the one or more contours by recognizing one or more patterns that proposes a probability of the presence of the cavity.

4. The system as claimed in claim 1 wherein the machine learning model is trained using at least one set of training images and corresponding labels, wherein the at least one set of training images comprises a plurality of images of teeth and associated cavities.

5. The system as claimed in claim 1 wherein the machine learning model is configured with a training set of various sizes of dental images thereby producing accuracy in the probability of occurrence of the cavity.

6. The system as claimed in claim 1 wherein the one or more filters comprises a two-dimensional convolution high pass filter, a binary threshold filter, a contour recognition filter, a color based contour filter and a hierarchical based contour filter.

7. The system as claimed in claim 1 wherein the pre-processing module is configured to perform at least one of an upscale of the one or more contours and a downscale of the one or more contours to increase resolution of the dental image.

8. The system as claimed in claim 1 wherein the label is a binary value that represents one of a presence and absence of the cavity within the one or more contours of the dental image.

9. The system as claimed in claim 1 wherein the dental image is a color image of a tooth of the user.

10. A computer-implemented method for probabilistic detection of tooth cavities using machine learning comprising:
receiving, by an image acquisition module of a processing subsystem, a dental image from an image capturing device coupled to a computing device;
identifying, by a contour detection module of the processing subsystem, a plurality of contours from a dental image thereby selecting a plurality of areas of interest to analyze for a probability of occurrence of a cavity in the dental image;
processing, by the contour detection module of the processing subsystem, the plurality of contours by applying one or more filters thereby converting the dental image into a corresponding grayscale image;
allowing, by a user selection module of the processing subsystem, a user to select one or more contours from the plurality of contours identified by the contour detection module;
isolating, by a pre-processing module of the processing subsystem, each of one or more contours, selected by the user, into one or more bounding boxes based on a ratio using a machine learning model;
converting, by the pre-processing module of the processing subsystem, the one or more bounding boxes into corresponding pre-defined pixels using the machine learning model;
analyzing, by a machine learning pipeline of the processing subsystem, the one or more contours using the machine learning model, upon isolating, thereby identifying the presence of a cavity; and
displaying, by an output module of the processing subsystem, a label corresponding to each of the one or more contours, wherein the label indicates a probability of occurrence of a cavity.

11. A non-transitory computer-readable medium storing a computer program that, when executed by a processor, causes the processor to perform a computer-implemented method for probabilistic detection of tooth cavities using machine learning, wherein the computer-implemented method comprises:
receiving, by an image acquisition module of a processing subsystem, a dental image from an image capturing device coupled to a computing device;
identifying, by a contour detection module of the processing subsystem, a plurality of contours from a dental image thereby selecting a plurality of areas of interest to analyze for a probability of occurrence of a cavity in the dental image;
processing, by the contour detection module of the processing subsystem, the plurality of contours by applying one or more filters thereby converting the dental image into a corresponding grayscale image;
allowing, by a user selection module of the processing subsystem, a user to select one or more contours from the plurality of contours identified by the contour detection module;
isolating, by a pre-processing module of the processing subsystem, each of one or more contours, selected by the user, into one or more bounding boxes based on a ratio using a machine learning model;
converting, by the pre-processing module of the processing subsystem, the one or more bounding boxes into corresponding pre-defined pixels using the machine learning model;
analyzing, by a machine learning pipeline of the processing subsystem, the one or more contours using the machine learning model, upon isolating, thereby identifying the presence of a cavity; and
displaying, by an output module of the processing subsystem, a label corresponding to each of the one or more contours, wherein the label indicates a probability of occurrence of a cavity.
